(19) United States
(12) Patent Application Publication
(10) Pub. No.: US 2019/0246067 A1
(43) Pub. Date: Aug. 8, 2019

(54) METHOD AND APPARATUS FOR ACTIVATING FORWARD VIEW

(71) Applicant: GM GLOBAL TECHNOLOGY OPERATIONS LLC, Detroit, MI (US)

(72) Inventor: Fred W. Huntzicker, Ann Arbor, MI (US)

(21) Appl. No.: 15/889,661

(22) Filed: Feb. 6, 2018

(51) Int. Cl. H04N 7/18; G06K 9/00

(52) U.S. Cl. CPC H04N 7/18; G06K 9/00791

(57) ABSTRACT

A method and apparatus for initiating display of a forward view are provided. The method includes detecting an activation of garage door control, determining whether a forward moving gear is selected, and displaying a forward view in response to detecting the activation of the garage door control and determining that the forward moving gear is selected.

### INTRODUCTION

Apparatuses and methods consistent with exemplary embodiments relate to providing views of an area outside of a vehicle. More particularly, apparatuses and methods consistent with exemplary embodiments relate to activating views of an area outside of a vehicle.

### SUMMARY

One or more exemplary embodiments provide a method and an apparatus that activate a forward view. More particularly, one or more exemplary embodiments provide a method and an apparatus that activate a forward view when approaching a garage or parking area.

According to an aspect of an exemplary embodiment, a method for initiating display of a forward view is provided. The method includes detecting an activation of garage door control, determining whether a forward moving gear is selected, and displaying a forward view in response to detecting the activation of the garage door control and determining that the forward moving gear is selected.

The detecting the activation of the garage door control may include detecting a press of a garage door button or detecting a garage door actuation signal. The detecting the activation of the garage door control may include detecting a garage door open control.

The detecting the activation of the garage door control may include detecting an activation of a garage door button of a garage door transmitter.

The method may include determining whether automatic forward view displaying is enabled, and the displaying the forward view may be performed in response to detecting the activation of the garage door control, determining that the forward moving gear is selected, and determining that the automatic forward view displaying is enabled.

The forward view may be a forward view of a vehicle, and the method may include determining a speed of the vehicle. The displaying the forward view may be performed in response to detecting the activation of the garage door control, determining that the forward moving gear is selected, determining that the automatic forward view displaying is enabled, and the determined speed being less than a predetermined threshold speed.

The forward view is a forward view of a vehicle, and the method may further include determining a speed of the vehicle. The displaying the forward view may be performed in response to detecting the activation of the garage door control, determining that the forward moving gear is selected, and the determined speed being less than a predetermined threshold speed.

The determining whether a forward moving gear is selected may include determining that a gear shifter is selecting a forward moving gear of a vehicle.

The displaying the forward view may include displaying the forward view in at least one from among an instrument panel display, a rear view mirror display, and a center stack module display.

According to an aspect of an exemplary embodiment, a non-transitory computer readable medium comprising computer executable instructions executable by a processor to perform a method is provided. The method includes detecting an activation of garage door control, determining whether a forward moving gear is selected, and displaying a forward view or a side view in response to detecting the activation of the garage door control and determining that the forward moving gear is selected

According to an aspect of another exemplary embodiment, an apparatus for initiating display of a forward view is provided. The apparatus includes at least one memory comprising computer executable instructions; and at least one processor configured to read and execute the computer executable instructions. The computer executable instructions cause the at least one processor to detect an activation of garage door control, determine whether a forward moving gear is selected, and display a forward view in response to detecting the activation of the garage door control and determining that the forward moving gear is selected.

The apparatus may include garage door transmitter including a garage door button configured to generate a garage door control signal, and the computer executable instructions may cause the at least one processor to detect the activation of the garage door control by detecting a press of the garage door button or detecting the garage door actuation signal.

The computer executable instructions may cause the at least one processor to detect the activation of the garage door control by detecting a garage door open control.

The computer executable instructions may also cause the at least one processor to detect the activation of the garage door control by detecting an activation of a garage door button of a garage door transmitter.

The computer executable instructions may also cause the at least one processor to determine whether automatic forward view displaying is enabled, and to display the forward view in response to detecting the activation of the garage door control, determining that the forward moving gear is selected, and determining that the automatic forward view displaying is enabled.

The forward view may be a forward view of a vehicle, and the computer executable instructions may cause the at least one processor to determine a speed of the vehicle, and to display the forward view in response to detecting the activation of the garage door control, determining that the forward moving gear is selected, determining that the automatic forward view displaying is enabled, and the determined speed being less than a predetermined threshold speed.

The forward view may be a forward view of a vehicle, and the computer executable instructions may cause the at least one processor to determine a speed of the vehicle, and to display the forward view in response to detecting the activation of the garage door control, determining that the forward moving gear is selected, and the determined speed being less than a predetermined threshold speed.

The apparatus may include a gear shifter, and the computer executable instructions may cause the at least one processor to determine whether a forward moving gear is actuated by determining that the gear shifter is selecting a forward moving gear of a vehicle.

The apparatus may include at least one from among an instrument panel display, a rear view mirror display, and a center stack module display, an the computer executable instructions may cause the at least one processor to display the forward view by displaying the forward view in the at least one from among the instrument panel display, the rear view mirror display, and the center stack module display.

The computer executable instructions may also cause the at least one processor to determine a location of the vehicle, and to display the forward view in response to detecting the activation of the garage door control, determining that the forward moving gear is selected, and the determined location being a location corresponding to a garage associated with the garage door control.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that initiates display of a forward view according to an exemplary embodiment; and

FIG. 2 shows a flowchart for a method for initiating display of a forward view according to an exemplary embodiment.

### DETAILED DESCRIPTION

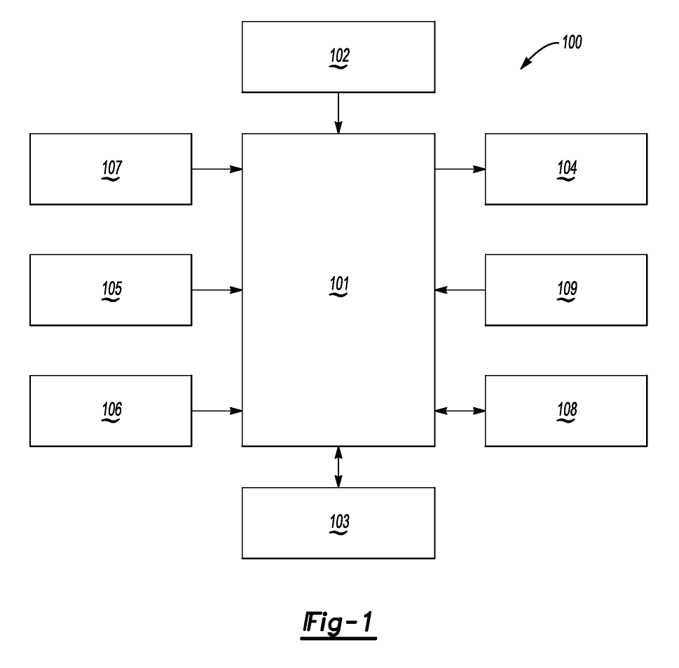

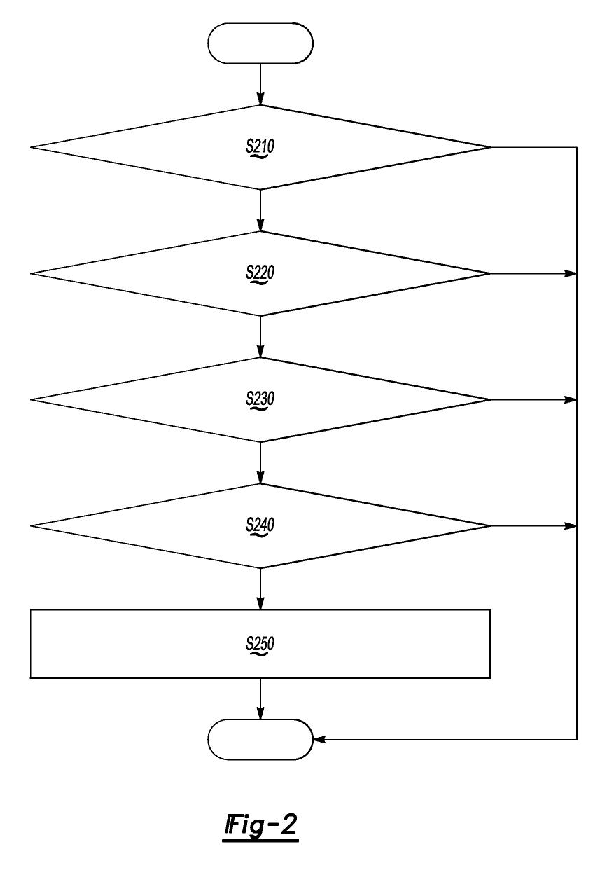

An apparatus and method that initiate display of a forward view will now be described in detail with reference to FIGS. 1 and 2 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or combined into one or more devices. In addition, individual elements may be provided on separate devices.

Vehicles such as passenger cars, trucks, sports utility vehicles (SUVs), recreational vehicles (RVs), marine vessels, aircraft, etc., may include imaging devices that provide a view of an area outside of a vehicle. One such imaging device may provide a forward view of an area in front of a vehicle. In the case of a forward imaging device, it is desirable to activate or initiate displaying the forward view in situations or at a time when the display of the forward view would assist an operator of the vehicle. Examples of such situations may include entering into a garage or a parking space.

FIG. 1 shows a block diagram of an apparatus that initiates display of a forward view 100 according to an exemplary embodiment. As shown in FIG. 1, the apparatus that initiates display of a forward view 100 according to an exemplary embodiment includes a controller 101, a power supply 102, a storage 103, an output 104, an image sensor 105, a user input 106, a garage door control 107, a communication device 108 and a gear shifter 109. However, the apparatus that initiates display of a forward view 100 is not limited to the aforementioned configuration and may be configured to include additional elements and/or omit one or more of the aforementioned elements. The apparatus that initiates display of a forward view 100 may be implemented as part of a vehicle or as a standalone component.

The controller 101 controls the overall operation and function of the apparatus that initiates display of a forward view 100. The controller 101 may control one or more of a storage 103, an output 104, an image sensor 105, a user input 106, a garage door control 107, a communication device 108, and a gear shifter 109 of the apparatus that initiates display of a forward view 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the output 104, the image sensor 105, the user input 106, a garage door control 107, the communication device 108, and the gear shifter 109 of the apparatus that initiates display of a forward view 100. The information may be sent and received via a bus or network, or may be directly read or written to/from one or more of the storage 103, the output 104, the image sensor 105, the user input 106, the garage door control 107, the communication device 108 and the gear shifter 109 of the apparatus that initiates display of a forward view 100. Examples of suitable network connections include a controller area network (CAN), a media oriented system transfer (MOST), a local interconnection network (LIN), a local area network (LAN), and other appropriate connections such as Ethernet.

The power supply 102 provides power to one or more of the controller 101, the storage 103, the output 104, the image sensor 105, the user input 106, the garage door control 107, the communication device 108, and the gear shifter 109 of the apparatus that initiates display of a forward view 100. The power supply 102 may include one or more from among a battery, an outlet, a capacitor, a solar energy cell, a generator, a wind energy device, an alternator, etc.

The storage 103 is configured for storing information and retrieving information used by the apparatus that initiates display of a forward view 100. The storage 103 may be controlled by the controller 101 to store and retrieve image sensor information from image sensor 105, location information, speed information, gear shifter information, garage door control information. The storage 103 may also include the computer instructions configured to be executed by a processor to perform the functions of the apparatus that initiates display of a forward view 100.

The image sensor information may include an image of an area around a vehicle such as an area in front of a vehicle. The location information may be determined by through information provided by communication device 108 and may include a location of a vehicle. The speed information may be provided by a speedometer or other device, and may include information about a speed or velocity of a vehicle. The gear shifter information may include information on a selected gear or a status of a transmission of a vehicle provided by the gear shifter 109. The garage door control information may be information indication that the garage door function has been activated from the garage door control 107.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 is configured to output information in one or more forms including: visual, audible and/or haptic form. The output 104 may be controlled by the controller 101 to provide outputs to the user of the apparatus that initiates display of a forward view 100. The output 104 may include one or more from among a speaker, a display, a transparent display, a centrally-located display, a head up display, a windshield display, a haptic feedback device, a vibration device, a tactile feedback device, a tap-feedback device, a holographic display, an instrument light, an indicator light, a horn, a piezoelectric device, etc. In addition, the output 104 may also include a transparent display located on one or more of a windshield, a rear window, side windows, and mirrors of a vehicle.

The output 104 may output an image provided by image sensor 105. The output image may be of an area in front of a vehicle, behind a vehicle, a side of vehicle, etc. In addition, the output 104 may output a notification including one or more from among an audible notification, a light notification, and a display notification. The notification may correspond to the displaying of the image of image sensor 105. For example, the notification can indicate initiation of the display of the image of image sensor 105 or may be an audible notification corresponding to an obstacle in an area shown in the image of image sensor 105.

The image sensor 105 may be one or more from among a camera, an electronic imaging device, a LIDAR, a CMOS imager, an ultrasonic imager, an infrared imager, and a charge coupled device. The image sensor 105 may image an area around a vehicle. The imager 105 may be mounted in a panel of a vehicle, a mirror, a bumper, a hood, etc. The image sensor 105 may include circuitry configured to output image sensor information including an image of an area around a vehicle such as an area in front of a vehicle, an area at the side of a vehicle, or an area in the rear of the vehicle.

The user input 106 is configured to provide information and commands to the apparatus that initiates display of a forward view 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the alert or notification output by the output 104. The user input 106 may also be configured to receive a user input to cycle through notifications or different screens of a notification.

The garage door control 107 is configured to transmit or output a signal to control a garage door actuator. The signal may trigger an actuator of the garage door to open or close the garage door. The garage door control may be a transmitter configured to output a wireless signal in response to a press of button of the garage door control 107. The controller 101 may be configured to detect the wireless signal or may detect the press the button of the garage door control 107. The wireless signal or the press the button of the garage door control 107 may control to open the garage door or open a door or gate to a parking space.

The communication device 108 may be used by the apparatus that initiates display of a forward view 100 to communicate with various types of internal or external apparatuses according to various communication methods. The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long term evolution (LTE), Bluetooth, EVDO, CDMA, GPRS, EDGE or ZigBee.

The gear shifter 109 may be a vehicle gear shifter comprising circuitry and/or other physical components configured to transfer energy from the propulsion system to move the vehicle or the wheels of the vehicle to propel a vehicle according to a selected gear. The gear shifter 109 may transfer the energy to move the vehicle forward, backward, etc. The controller 101 may detect a selected gear of the gear shifter 109.

The controller 101 of the apparatus that initiates display of a forward view 100 may be configured to detect an activation of garage door control 107, determine whether a forward moving gear of the gear shifter or transmission is selected, and display a forward view or a side view in response to detecting the activation of the garage door control and determining that the forward moving gear is selected. The activation of garage door control 107 may control to open the garage door. The forward view or side view may be a forward or side view of a vehicle. The controller 101 of the apparatus that initiates display of a forward view 100 may be configured to determine whether a forward moving gear is actuated by determining that the gear shifter is selecting a forward moving gear of a vehicle.

The controller 101 of the apparatus that initiates display of a forward view 100 may also be configured to determine whether automatic forward view displaying is enabled, and to display the forward view in response to detecting the activation of the garage door control, determining that the forward moving gear is selected, and determining that the automatic forward view displaying is enabled.

The controller 101 of the apparatus that initiates display of a forward view 100 may also be configured to determine a speed of the vehicle, and to display the forward view in response to detecting the activation of the garage door control, determining that the forward moving gear is selected, determining that the automatic forward view displaying is enabled, and the determined speed being less than a predetermined threshold speed

The controller 101 of the apparatus that initiates display of a forward view 100 may also be configured to determine a location of the vehicle, and to display the forward view in response to detecting the activation of the garage door control, determining that the forward moving gear is selected, and the determined location being a location corresponding to a garage associated with the garage door control.

FIG. 2 shows a flowchart for a method for initiating display of a forward view according to an exemplary embodiment. The method of FIG. 2 may be performed by the apparatus that initiates display of a forward view 100 or may be encoded into a computer readable medium as instructions that are executable by a computer to perform the method.

Referring to FIG. 2, it is determined whether an activation of garage door control is detected in operation S210. If the activation is not detected (operation S210—No), the method ends. If the activation is detected (operation S210—Yes), then it is determined whether automatic forward view displaying is enabled in operation S220.

If it is determined that automatic forward view displaying is enabled (operation S220—Yes), then it is determined whether forward moving gear is selected in operation S230. If it is determined that the automatic forward view displaying is not enabled (operation S220—No), the method ends.

If the forward moving gear is selected (operation S230—Yes), then it is determined whether the speed of the vehicle is below a threshold speed in operation S240. If the forward moving gear is not selected (operation S230—No), then the method ends. If the speed of the vehicle below a threshold speed (operation S240—Yes), then the forward view is displayed in operation S250. If the speed of the vehicle is not below the threshold speed (operation S240-No), then the method ends without displaying the forward view. In various other examples, operations S210-S240 may be performed in any order or may be performed concurrently.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method for initiating display of a forward view, the method comprising:
detecting an activation of garage door control;
determining whether a forward moving gear is selected; and
displaying a forward view in response to detecting the activation of the garage door control and determining that the forward moving gear is selected.

2. The method of claim 1, wherein the detecting the activation of the garage door control comprises detecting a press of a garage door button or detecting a garage door actuation signal.

3. The method of claim 2, wherein the detecting the activation of the garage door control comprises detecting a garage door open control.

4. The method of claim 1, wherein the detecting the activation of the garage door control comprises detecting an activation of a garage door button of a garage door transmitter.

5. The method of claim 1, further comprising determining whether automatic forward view displaying is enabled,
wherein the displaying the forward view is performed in response to detecting the activation of the garage door control, determining that the forward moving gear is selected, and determining that the automatic forward view displaying is enabled.

6. The method of claim 5, wherein the forward view is a forward view of a vehicle, and the method further comprises determining a speed of the vehicle,
wherein the displaying the forward view is performed in response to detecting the activation of the garage door control, determining that the forward moving gear is selected, determining that the automatic forward view displaying is enabled, and the determined speed being less than a predetermined threshold speed.

7. The method of claim 1, wherein the forward view is a forward view of a vehicle, and the method further comprises determining a speed of the vehicle,
wherein the displaying the forward view is performed in response to detecting the activation of the garage door control, determining that the forward moving gear is selected, and the determined speed being less than a predetermined threshold speed.

8. The method of claim 1, wherein the determining whether a forward moving gear is selected comprises determining that a gear shifter is selecting a forward moving gear of a vehicle.

9. The method of claim 1, wherein the displaying the forward view comprises displaying the forward view in at least one from among an instrument panel display, a rear view mirror display, and a center stack module display.

10. A non-transitory computer readable medium comprising computer executable instructions executable by a processor to perform a method, the method comprising:
detecting an activation of garage door control;
determining whether a forward moving gear is selected; and
displaying a forward view or a side view in response to detecting the activation of the garage door control and determining that the forward moving gear is selected

11. An apparatus that initiates display of a forward view, the apparatus comprising:
at least one memory comprising computer executable instructions; and
at least one processor configured to read and execute the computer executable instructions, the computer executable instructions causing the at least one processor to:
detect an activation of garage door control;
determine whether a forward moving gear is selected; and
display a forward view in response to detecting the activation of the garage door control and determining that the forward moving gear is selected.

12. The apparatus of claim 13, further comprising a garage door transmitter including a garage door button configured to generate a garage door control signal,
wherein the computer executable instructions cause the at least one processor to detect the activation of the garage door control by detecting a press of the garage door button or detecting the garage door actuation signal.

13. The apparatus of claim 14, wherein the computer executable instructions cause the at least one processor to detect the activation of the garage door control by detecting a garage door open control.

14. The apparatus of claim 11, wherein the computer executable instructions further cause the at least one processor to detect the activation of the garage door control by detecting an activation of a garage door button of a garage door transmitter.

15. The apparatus of claim 11, wherein the computer executable instructions further cause the at least one processor to determine whether automatic forward view displaying is enabled, and to display the forward view in response to detecting the activation of the garage door control, determining that the forward moving gear is selected, and determining that the automatic forward view displaying is enabled.

16. The apparatus of claim 15, wherein the forward view is a forward view of a vehicle, and
wherein the computer executable instructions further cause the at least one processor to determine a speed of the vehicle, and to display the forward view in response to detecting the activation of the garage door control, determining that the forward moving gear is selected, determining that the automatic forward view displaying is enabled, and the determined speed being less than a predetermined threshold speed

17. The apparatus of claim 11, wherein the forward view is a forward view of a vehicle, and
wherein the computer executable instructions further cause the at least one processor to determine a speed of the vehicle, and to display the forward view in response to detecting the activation of the garage door control, determining that the forward moving gear is selected, and the determined speed being less than a predetermined threshold speed.

18. The apparatus of claim 11, further comprising a gear shifter,
wherein the computer executable instructions further cause the at least one processor to determine whether a forward moving gear is actuated by determining that the gear shifter is selecting a forward moving gear of a vehicle.

19. The apparatus of claim 11, further comprising at least one from among an instrument panel display, a rear view mirror display, and a center stack module display,
wherein the computer executable instructions further cause the at least one processor to display the forward view by displaying the forward view in the at least one from among the instrument panel display, the rear view mirror display, and the center stack module display.

20. The apparatus of claim 13, wherein the computer executable instructions further cause the at least one processor to determine a location of the vehicle, and to display the forward view in response to detecting the activation of the garage door control, determining that the forward moving gear is selected, and the determined location being a location corresponding to a garage associated with the garage door control.
